(19) United States
(12) Patent Application Publication
(10) Pub. No.: US 2004/0075250 A1
(43) Pub. Date: Apr. 22, 2004

(54) Front pillar trim structure for curtain air bag of a vehicle

(75) Inventor: Hyeong Ho Choi, Gwangmyoung (KR)

Correspondence Address: MORGAN, LEWIS & BOCKIUS, LLP., 3300 HILLVIEW AVENUE, PALO ALTO, CA, 94304, US

(73) Assignee: Kia Motors Corporation

(21) Appl. No.: 10/377,816

(22) Filed: Feb. 27, 2003

(30) Foreign Application Priority Data
Oct. 16, 2002 (KR) 2002-63244

(51) Int. Cl. B60R 21/20

(52) U.S. Cl. 280/728.3

(57) ABSTRACT

A front pillar trim structure for a curtain air bag of a vehicle comprises a front pillar trim and a front pillar panel provided on a lateral chassis of the vehicle. A curtain air bag is housed within the front pillar trim. A spring member has two free ends connected into fixing holes formed at the cylindrical body of the fixing cap, and a fixing screw. The spring member is wound around the fixing screw, such that during a side impact collision the front pillar trim is prevented from disengaging from the front pillar panel. Furthermore, the curtain air bag is deployed in a predetermined direction to protect the occupants of the vehicle.

### FIELD OF THE INVENTION

The present invention relates to the trim for a front pillar of a vehicle. More particularly, the present invention relates to a front pillar trim structure that houses a curtain air bag where the trim remains engaged during the deployment of the curtain air bag in the event of a collision.

### BACKGROUND OF THE INVENTION

Air bags have been studied since the 1970s and were introduced into mass production around 1986. Air bag popularity and globalization began when the National Highway Traffic Safety Administration (NHTSA) made them mandatory on vehicles sold in the United States. Also, air bags began to be mounted on vehicles in Korea, in large scale, during the early 1990s.

Typically, the air bag is designed to deploy in case of a vehicle collision. An impact sensor operates to ignite solid chemicals housed in the air bag, sequentially generating inflatable gases in the interval from 0.02 to 0.05 seconds, and thereby inflating the air bag. Occupants of the vehicle are thus prevented from directly colliding with the surrounding vehicular structure during an accident. As a result, the occupants have a strong possibility of escaping injury or death even in serious collisions.

However, loss of human life remains typically very high during side impact collisions. For example, traffic accident figures in the USA alone show that casualties from side impact collisions amounted to 30% of the total casualties for a particular year. For this reason, certain automobile models have a curtain air bag along the side roofline of their vehicles in addition to side air bags and front air bags.

Curtain air bags have become more common recently. For example, they are recommended for SUV's in particular because these types of vehicles are vulnerable to roll over during traffic accidents. However, even with the curtain air bag, the vehicle occupants are still at risk of injury because current curtain air bags generally do not cover the side windows properly. This is because of the structure of the traditional front pillar trim. Furthermore, during deployment of the curtain airbag, the front pillar trim, along with its securing fasteners and screws, become disengaged and cause damage to the occupants of the vehicle.

### SUMMARY OF THE INVENTION

The present invention provides a front pillar trim structure for a curtain air bag of a vehicle comprising a front pillar trim and a front pillar panel provided on a lateral chassis of the vehicle. Also included is a curtain air bag housed within the front pillar trim, wherein the front pillar trim is provided with a step section where a portion of the front pillar trim is folded in a downward direction. A fixing cap in the shape of a cylindrical body that is hollowed out is seated in the step section. A spring member having two free ends connected to fixing holes formed in the cylindrical body of the fixing cap and a fixing screw, which the spring member is attached to, is fastened through the front pillar panel underneath the fixing cap with a nut. During side impact, the front pillar trim is prevented from separating from the front pillar panel. Furthermore, the curtain air bag can enclose the front and rear door or window glass owing to its easy deployment.

In a preferred embodiment, to prevent disengagement of the spring member from the fixing cap, a clip is provided at a connecting portion between the fixing cap and the spring member. In addition, the present invention can provide a simplified process for assembling the front pillar trim of a vehicle by integrally forming the fixing screw and the fixing cap.

A front pillar trim structure for a curtain air bag of a vehicle comprises a housing member attached to a pillar panel of a vehicle by an extendable member. Also included is a curtain air bag housed within said housing member. Upon deployment of the curtain air bag the housing member disengages from the pillar panel a predetermined distance until the extendable member become engaged, thereby, stopping further disengagement of the housing member and providing an opening for protrusion of the deploying curtain air bag.

In an alternative embodiment the opening for protrusion of the deploying curtain air bag is a directed opening such that the curtain air bag deploys in a predetermined direction.

In a further alternative embodiment the extendable member couples between a fixing cap of the housing member and a fastening member coupled with the pillar panel.

It is preferred that the extendable member is coupled with the housing member by a clip.

A curtain air bag structure of the present invention comprises a front pillar panel and a housing member disposed adjacent to the front pillar panel that defines a space there between. Also includes is an air bag disposed in the space. Furthermore, an extendable member securing the housing member to the front pillar panel is included. The extendable member is configured and dimensioned to permit separation of the housing member from the front pillar panel a sufficient distance for deployment of the air bag from the space and to limit movement of the housing member to a predetermined distance.

In a preferred embodiment the extendable member is a spring attached to the front pillar panel.

### BRIEF DESCRIPTION OF THE DRAWINGS

The present invention will be more clearly understood from the following detailed description read in conjunction with the accompanying drawings, in which:

FIG. 1 is a schematic view illustrating a lateral chassis of a vehicle having a front pillar trim for a curtain air bag according to an embodiment of the present invention;

FIG. 2 is a sectional view taken along line II-II of FIG. 1;

FIG. 3 is a perspective view showing a connection between a fixing cap and a fixing screw according to an embodiment of the present invention;

FIG. 4 is a sectional view illustrating initial deployment of a curtain air bag housed in a front pillar trim according to an embodiment of the present invention; and

FIG. 5 is a schematic view illustrating deployment of the curtain air bag of the vehicle of FIG. 1.

### DETAILED DESCRIPTION OF THE PREFERRED EMBODIMENT

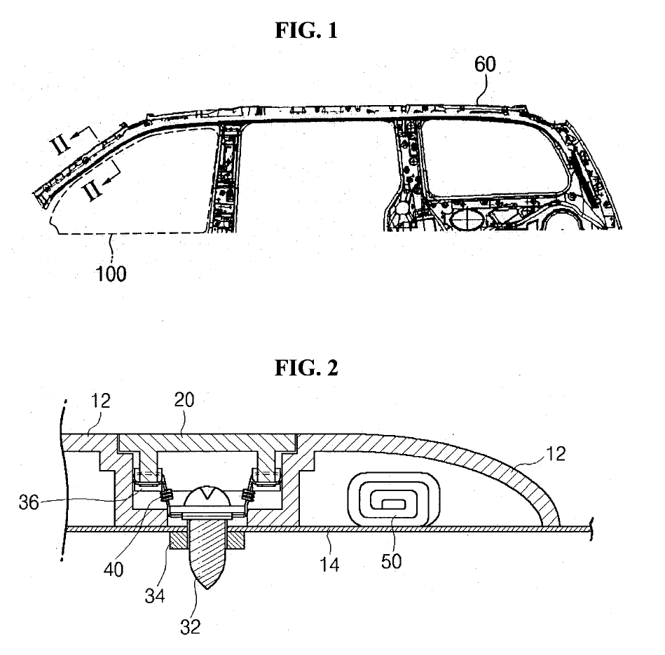

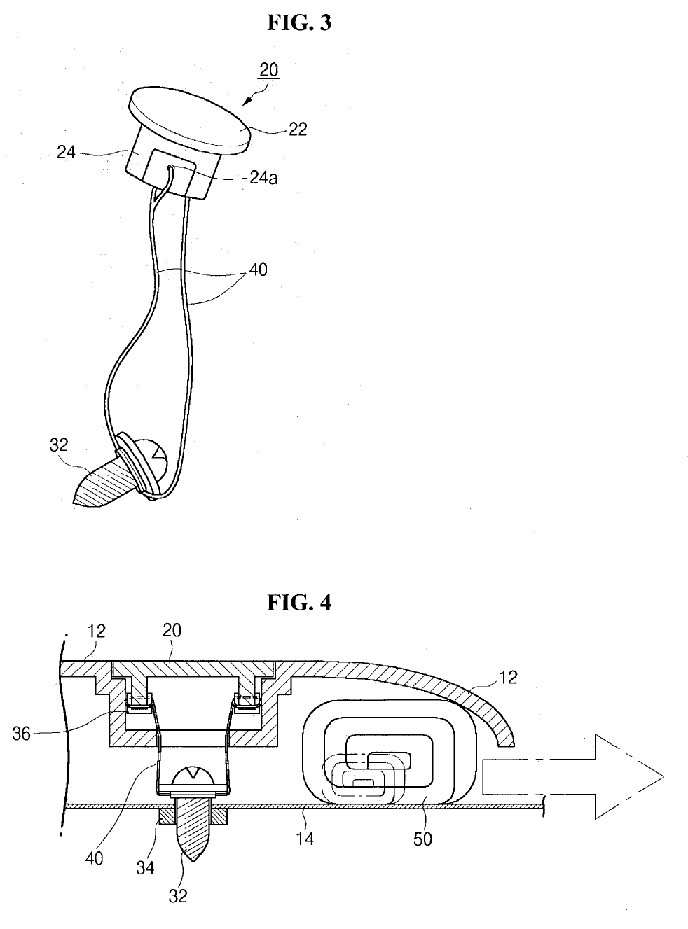

FIGS. 1-3 show a front pillar trim for curtain air bags according to an embodiment of the present invention. The front pillar trim 12 is designed so that the curtain air bag 50, housed within a lateral chassis 60 in a vehicle is deployed downward through a head lining and the front pillar trim 12. Numeral reference 100, FIG. 1, shows the front door glass of a vehicle that is covered by the curtain air bag 50 upon deployment.

The front pillar trim 12 is preferably provided with a step section, which is folded downward toward a front pillar panel 14. The curtain air bag 50 is housed in a space between the step section and an end closely contacted with the front pillar panel 14. A fixing cap 20 is designed so that its head 22 is disposed on a first or upper step of the step section of the front pillar trim 12. The body 24 of the fixing cap 20 extends toward and around the edge of the head 22. It is preferable that the fixing cap 20 takes a shape of a hollowed out cylindrical body.

A spring member 40 has two free ends connected to fixing holes 24a of the fixing cap 20. In another embodiment, the free ends of the spring member 40 can be attached to the hollow body 24 of the fixing cap 20 by a clip 36.

A fixing screw 32 is adapted to fasten the front pillar trim 12 to the front pillar panel 14. The threaded body of the fixing screw 32 passes through a second or lower step of the step section of the front pillar trim 12 and the front pillar panel 14. The fixing screw 32 is further fastened with a nut 34 of the front pillar panel 14. A spring member 40 fastens the front pillar trim 12 to the fixing screw 32, thereby, elastically supporting the front pillar trim 12. In a preferable embodiment the spring member 40 is made of a wire material and is wound around the fixing screw at least one turn, such that it is fixed with the fixing screw 32.

FIG. 4 illustrates deployment of the curtain air bag 50 during a side impact collision. The curtain air bag 50 is initially caused to be inflated with inflatable gases by means of an impact sensor. The impact sensor (not shown) senses a side impact on the vehicle and triggers the inflatable gasses to inflate the curtain air bag 50. During deployment, the front pillar trim 12 is pushed away from the front pillar panel 14 by the inflating air bag 50. However, the front pillar trim 12 is stopped from being completely disengaged from the front pillar panel 14 by the spring member 40. Further, because the front pillar trim 12 is maintained in a predetermined position by the spring member 40 during deployment, the curtain air bag 50 is deployed in a predetermined direction as represented by the arrow.

The present invention preferably provides that the front pillar trim 12 is elastically spaced away from or made to contact with the front pillar panel 14 by the spring member 40, without being disengaged from the front pillar panel 14.

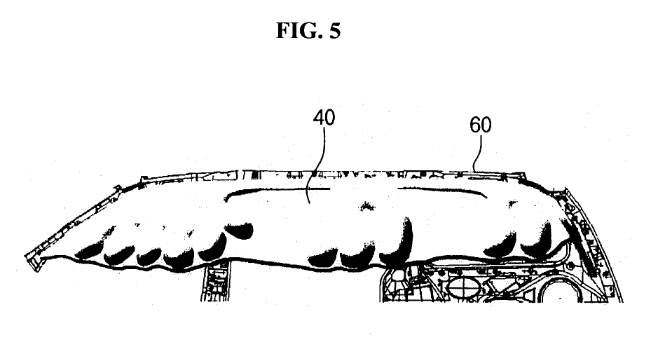

As shown in FIG. 5, when a vehicle is subjected to a side impact collision, the curtain air bag 50 is deployed, covering the front door glass surrounding the driver's seat or the front passenger's side seat. Furthermore, in an alternative embodiment, the curtain air bag 50 also covers the rear door or window glass surrounding the rear seats. Therefore, even though the glass is often broken in a side impact collision, secondary injury to the passengers, caused by the driver and fellow passengers being expelled from the vehicle is reduced.

While the present invention mentioned above has been shown and described in connection with the preferred embodiment, it is intended that the present invention is not limited to the foregoing embodiment but those skilled in the art can make various modifications and variations without departing from the principle and scope of the invention defined in the appended claims.

What is claimed is:

1. A front pillar trim structure for a curtain air bag of a vehicle, comprising:
a front pillar trim and a front pillar panel provided on a lateral chassis; and
a curtain air bag housed within said front pillar trim,
wherein said front pillar trim is provided with a step section where a portion of said front pillar trim is downwardly folded; a fixing cap, taking a shape of a hollowed out cylindrical body, is seated in the step section; a spring member having two free ends connected into fixing holes formed at the cylindrical body of the fixing cap; and a fixing screw, which said spring member is wound around, is fastened through said front pillar panel underneath the fixing cap with a nut.

2. The structure of claim 1, wherein a connection portion between said spring member and said fixing cap is clamped by a clip so as to prevent disengagement of said spring member from said fixing cap.

3. A front pillar trim structure for a curtain air bag of a vehicle, comprising:
a housing member attached to a pillar panel of a vehicle by an extendable member; and
a curtain air bag housed within said housing member,
wherein upon deployment of said curtain air bag said housing member disengages from said pillar panel a predetermined distance until said extendable member become engaged thereby stopping further disengagement of said housing member and providing an opening for protrusion of said deploying curtain air bag.

4. The structure of claim 3, wherein said opening for protrusion of said deploying curtain air bag is a directed opening such that said curtain air bag deploys in a predetermined direction.

5. The structure of claim 3, wherein said extendable member couples between a fixing cap of said housing member and a fastening member coupled with said pillar panel.

6. The structure of claim 3, wherein said extendable member is coupled with said housing member by a clip.

7. A curtain air bag structure, comprising:
a front pillar panel;
a housing member disposed adjacent the front pillar panel and defining a space there between;
an air bag disposed in said space; and
an extendable member securing the housing member to the front pillar panel, said extendable member being configured and dimensioned to permit separation of the housing member from the front pillar panel a sufficient distance for deployment of the air bag from said space and to limit movement of the housing member to a predetermined distance.

8. The structure of claim 7, wherein said extendable member comprises a spring attached to the front pillar panel.
